(19) United States
(12) Patent Application Publication
(10) Pub. No.: US 2011/0002387 A1
(43) Pub. Date: Jan. 6, 2011

(54) Techniques for motion estimation

(76) Inventors: Yi-Jen Chiu, San Jose, CA (US); Lidong Xu, Beijing (CN); Wenhao Zhang, Beijing (CN)

Correspondence Address: INTEL CORPORATION;c/o CPA Global, P.O. BOX 52050, MINNEAPOLIS, MN, 55402, US

(21) Appl. No.: 12/657,168

(22) Filed: Jan. 14, 2010

Related U.S. Application Data
(60) Provisional application No. 61/222,982, filed on Jul. 3, 2009.

(51) Int. Cl. H04N 7/26

(52) U.S. Cl. 375/240.15; 375/240.16; 375/E07.123

(57) ABSTRACT

Techniques are described that can be used to apply motion estimation (ME) based on reconstructed reference pictures in a B frame or in a P frame at a video decoder. For a P frame, projective ME may be performed to obtain a motion vector (MV) for a current input block. In a B frame, both projective ME and mirror ME may be performed to obtain an MV for the current input block. A metric an be used determining a metric for each pair of MV0 and MV1 that is found in the search path, where the metric is based on a combination of a first, second, and third metrics. The first metric is based on temporal frame correlation, a second metric is based on spatial neighbors of the reference blocks, and a third metric is based on the spatial neighbors of the current block.

### CROSS REFERENCE TO RELATED APPLICATIONS

This application is related to U.S. Provisional No. 61/222,982, filed on Jul. 3, 2009; U.S. Provisional No. 61/222,984, filed on Jul. 3, 2009; U.S. application Ser. No. 12/566,823, filed on Sep. 25, 2009 (attorney docket no. P31100); U.S. application Ser. No. 12/567,540, filed on Sep. 25, 2009 (attorney docket no. P31104); and U.S. application Ser. No. 12/582,061, filed on Oct. 20, 2009 (attorney docket no. P32772).

### RELATED ART

H.264, also known as advanced video codec (AVC), and MPEG-4 Part 10 are ITU-T/ISO video compression standards that are expected to be widely pursued by the industry. The H.264 standard has been prepared by the Joint Video Team (JVT), and consisted of ITU-T SG16 Q.6, known as VCEG (Video Coding Expert Group), and also consisted of ISO/IEC JTC1/SC29/WG11, known as MPEG (Motion Picture Expert Group). H.264 is designed for applications in the area of Digital TV broadcast (DTV), Direct Broadcast Satellite (DBS) video, Digital Subscriber Line (DSL) video, Interactive Storage Media (ISM), Multimedia Messaging (MMM), Digital Terrestrial TV Broadcast (DTTB), and Remote Video Surveillance (RVS).

Motion estimation (ME) in video coding may be used to improve video compression performance by removing or reducing temporal redundancy among video frames. For encoding an input block, traditional motion estimation may be performed at an encoder within a specified search window in reference frames. This may allow determination of a motion vector that minimizes the sum of absolute differences (SAD) between the input block and a reference block in a reference frame. The motion vector (MV) information can then be transmitted to a decoder for motion compensation. The motion vector can be determined for fractional pixel units, and interpolation filters can be used to calculate fractional pixel values.

Where original input frames are not available at the decoder, ME at the decoder can be performed using the reconstructed reference frames. When encoding a predicted frame (P frame), there may be multiple reference frames in a forward reference buffer. When encoding a bi-predictive frame (B frame), there may be multiple reference frames in the forward reference buffer and at least one reference frame in a backward reference buffer. For B frame encoding, mirror ME or projective ME may be performed to get the MV. For P frame encoding, projective ME may be performed to get the MV.

In other contexts, a block-based motion vector may be produced at the video decoder by performing motion estimation on available previously decoded pixels with respect to blocks in one or more frames. The available pixels could be, for example, spatially neighboring blocks in the sequential scan coding order of the current frame, blocks in a previously decoded frame, or blocks in a down-sampled frame in a lower layer when layered coding has been used. The available pixels can alternatively be a combination of the above-mentioned blocks.

In a traditional video coding system, ME is performed on the encoder side to determine motion vectors for the predictions of a current encoding block, and the motion vectors should be encoded into the binary stream and transmitted to the decoder side for the motion compensation of current decoding block. In some advanced video coding standards, e.g., H.264/AVC, a macro block (MB) can be partitioned into smaller blocks for encoding, and the motion vector can be assigned to each sub-partitioned block. As a result, if the MB is partitioned into 4×4 blocks, there are up to 16 motion vectors for a predictive coding MB and up to 32 motion vectors for a bi-predictive coding MB. As a result, substantial bandwidth is used to transmit motion vector information from encoder to decoder.

### BRIEF DESCRIPTION OF THE DRAWINGS

FIG. 1 depicts an example of a manner to determine motion vectors for a current block in a B frame using mirror ME.

FIG. 2 depicts an example of projective ME to determine motion vectors for a current block in a P frame based on two forward reference frames.

FIG. 3 shows an extended reference block.

FIG. 4 shows the spatial neighbors of the current block.

FIG. 5 depicts a process in accordance with an embodiment.

FIG. 6 illustrates an embodiment that can be used to determine motion vectors.

FIG. 7 illustrates an exemplary H.264 video encoder architecture that may include a self MV derivation module.

FIG. 8 illustrates an H.264 video decoder with a self MV derivation module.

### DETAILED DESCRIPTION

A digital video clip includes consecutive video frames. The motions of an object or background in consecutive frames may form a smooth trajectory, and motions in consecutive frames may have relatively strong temporal correlations. By utilizing this correlation, a motion vector can be derived for a current encoding block by estimating motion from reconstructed reference pictures. Determination of a motion vector at a decoder may reduce transmission bandwidth relative to motion estimation performed at an encoder.

Where original input pixel information is not available at the decoder, ME at the decoder can be performed using the reconstructed reference frames and the available reconstructed blocks of the current frame. Here, “available” means that the blocks have been reconstructed prior to the current block. When encoding a P frame, there may be multiple reference frames in a forward reference buffer. When encoding a B frame, there may be multiple reference frames in the forward reference buffer and at least one reference frame in a backward reference buffer.

The following discusses performing ME at a decoder, to obtain an MV for a current block, according to an embodiment. For B frame encoding, mirror ME or projective ME may be performed to determine the MV. For P frame encoding, projective ME may be performed to determine the MV. Note that the terms “frame” and “picture” are used interchangeably herein, as would be understood by a person of ordinary skill in the art.

Various embodiments provide for a decoder to determine a motion vector itself for a decoding block instead of receiving the motion vectors from the encoder. Decoder side motion estimation can be performed based on temporal frame correlation as well as based on the spatial neighbors of the reference blocks and on the spatial neighbors of the current block. For example, the motion vectors can be determined by performing a decoder side motion search between two reconstructed pictures in a reference buffer. For a block in a P picture, projective motion estimation (ME) can be used, and for a block in B picture, both projective ME and mirror ME can be used. Also, the ME can be performed on sub-partitions of the block type. Coding efficiency can be affected by applying adaptive search range for decoder side motion search. For example, techniques for determining a search range are described in U.S. patent application Ser. No. 12/582,061, filed on Oct. 20, 2009 (attorney docket no. P32772).

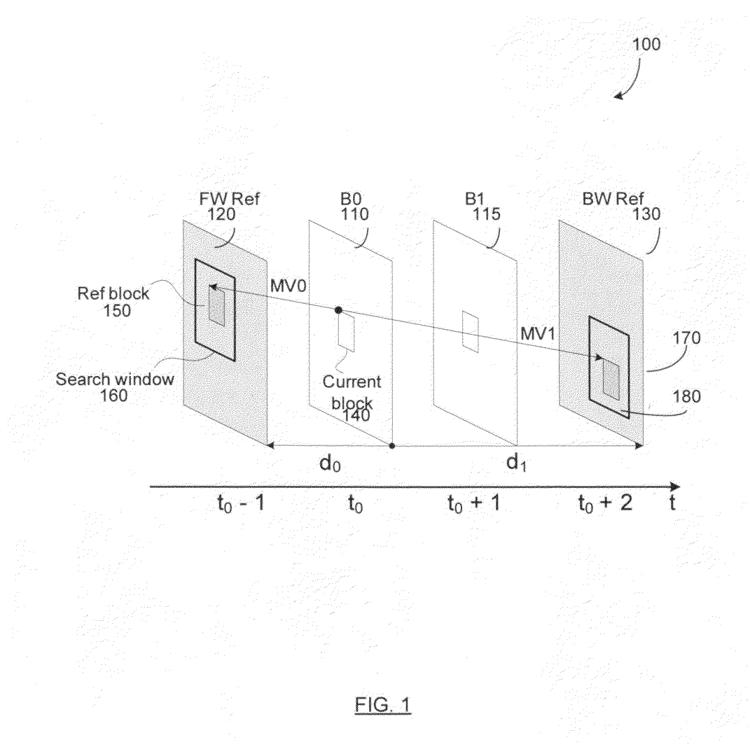

FIG. 1 depicts an example of a manner to determine motion vectors for a current block in a B frame using mirror ME. In the embodiment of FIG. 1, there may be two B frames, 110 and 115, between a forward reference frame 120 and a backward reference frame 130. Frame 110 may be the current encoding frame. When encoding the current block 140, mirror ME can be performed to get motion vectors by performing searches in search windows 160 and 170 of reference frames 120 and 130, respectively. As mentioned above, where the current input block may not be available at the decoder, mirror ME may be performed with the two reference frames.

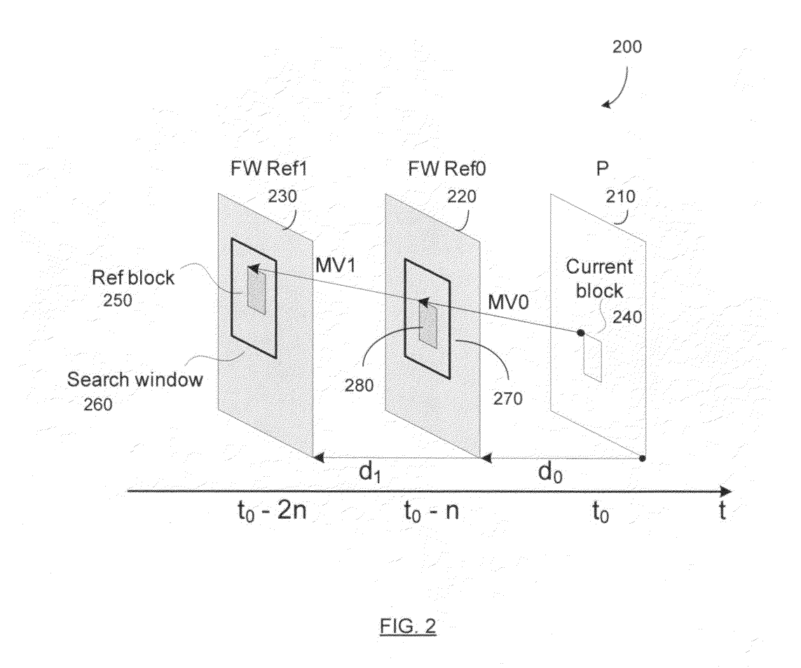

FIG. 2 depicts an example of projective ME to determine motion vectors for a current block in a P frame based on two forward reference frames, forward Ref0 (shown as reference frame 220) and forward Ref1 (shown as reference frame 230). These reference frames may be used to derive a motion vector for a target block 240 in a current frame 210. A search window 270 may be specified in reference frame 220, and a search path may be specified in search window 270. For each motion vector MV0 in the search path, its projective motion vector MV1 may be determined in search window 260 of reference frame 230. For each pair of motion vectors, MV0 and its associated motion vector MV1, a metric, such as a sum of absolute differences, may be calculated between (1) the reference block 280 pointed to by the MV0 in reference frame 220, and (2) the reference block 250 pointed to by the MV1 in reference frame 230. The motion vector MV0 that yields the optimal value for the metric, e.g., the lowest SAD, may then be chosen as the motion vector for target block 240.

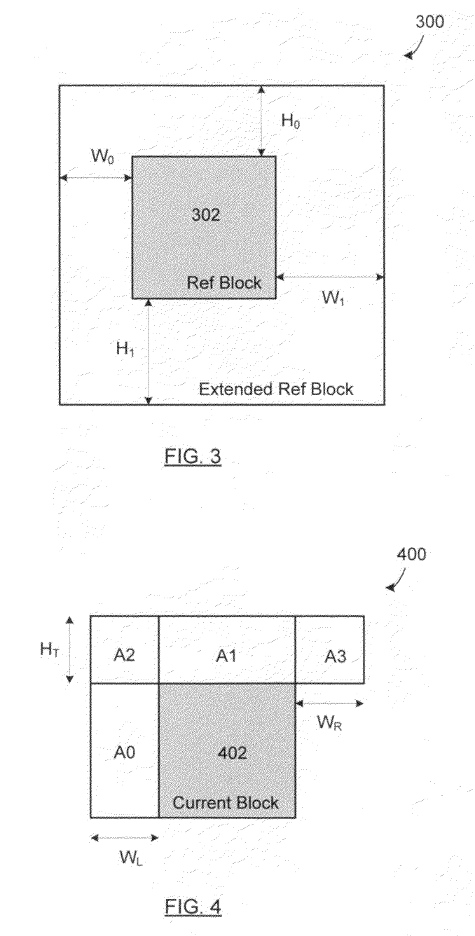

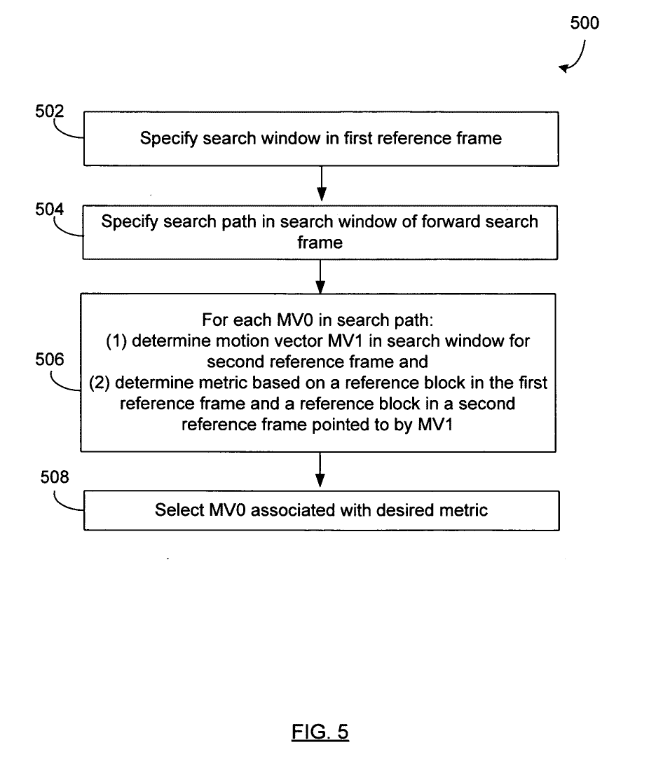

Techniques for determining the motion vectors for the scenarios described with regard to FIGS. 1 and 2 are described in respective FIGS. 2 and 4 of U.S. application Ser. No. 12/566,823, filed on Sep. 25, 2009 (attorney docket no. P31100).

An exemplary search for motion vectors may proceed as illustrated in processes 300 and 500 of U.S. application Ser. No. 12/566,823. The following provides a summary of the process to determine motion vectors for the scenario of FIG. 1 of this patent application. A search window may be specified in the forward reference frame. This search window may be the same at both the encoder and decoder. A search path may be specified in the forward search window. Full search or any fast search schemes can be used here, so long as the encoder and decoder follow the same search path. For an MV0 in the search path, its mirror motion vector MV1 may be obtained in the backward search window. Here it may be assumed that the motion trajectory is a straight line during the associated time period, which may be relatively short. A metric such as a sum of absolute differences (SAD) may be calculated between (i) the reference block pointed to by MV0 in the forward reference frame and (ii) the reference block pointed to by MV1 in the backward reference frame. These reference blocks may be shown as 150 and 180, respectively, in FIG. 1. A determination may be made as to whether any additional motion vectors MV0 exist in the search path. If so, the process may repeat and more than one MV0 may be obtained, where each MV0 has an associated MV1. Moreover, for each such associated pair, a metric, e.g., a SAD, may be obtained. The MV0 that generates a desired value for the metric, such as but not limited to, the lowest SAD, can be chosen. This MV0 may then be used to predict motion for the current block.

The following provides a summary of the process to determine motion vectors for the scenario of FIG. 2 of this patent application. A search window may be specified in a first forward reference frame. This window may be the same at both the encoder and decoder. A search path may be specified in this search window. Full search or fast search schemes may be used here, for example, so that the encoder and decoder may follow the same search path. For a motion vector MV0 in the search path, its projective motion vector MV1 may be obtained in the second search window. Here it may be assumed that the motion trajectory is a straight line over this short time period. A metric such as a SAD may be calculated between (i) the reference block pointed to by MV0 in the first reference frame and (ii) the reference block pointed to by MV1 in the second reference frame. A determination may be made as to whether there are any additional motion vectors MV0 that remain in the search path and that have not yet been considered. If at least one MV0 remains, the process may repeat, where for another MV0, its corresponding projective motion vector MV1 may be determined. In this manner, a set of pairs, MV0 and MV1, may be determined and a metric, e.g., a SAD, calculated for each pair. One of the MV0s may be chosen, where the chosen MV0 yields a desired value for the metric, such as but not limited to, the lowest SAD. A lowest available value for the SAD metric, i.e., a value closer to zero, may suggest a preferred mode, because an SAD metric of zero represents a theoretical optimal value. This MV0 may then be used to predict motion for the current block.

In various embodiments, to determine motion vectors, the sum of absolute difference (SAD) between the two mirror blocks or projective blocks in the two reference frames are determined. A current block size is M×N pixels and the position of the current block is represented by the coordinates of the current block's top-left pixel. In various embodiments, when the motion vector in reference frame R₀ is MV₀=(mv₀_{_{—}}x, mv₀_{_{—}}y) and the corresponding motion vector in the other reference frame R₁ is MV₁=(mv₁_{_{—}}x, mv₁_{_{—}}y), a motion search metric can be determined using equation (1).

J=J₀+α₁J₁+α₂J₂ (1)

J₀ represents a sum of absolute differences (SAD) that may be calculated between (i) the reference block pointed to by MV0 in the forward reference frame and (ii) the reference block pointed to by MV1 in the backward reference frame (or second forward reference frame in the scenario of FIG. 2) and described in U.S. application Ser. No. 12/566,823, filed on Sep. 25, 2009 (attorney docket no. P31100),

J₁ is the extended metric based on spatial neighbors of the reference block, and

J₂ is the extended metric based on the spatial neighbors of the current block, where α₁ and α₂ are two weighting factors. Factors α₁ and α₂ can be determined by simulations but are set to 1 by default.

The motion vector MV0 that yields the optimal value for the value J, e.g., the minimal SAD from equation (1) may then be chosen as the motion vector for the current block. Motion vector MV0 has an associated motion vector MV1, defined according to:

MV1=(d₁/d₀)*MV0

where,
when a current block is in a B picture, d₀ represents a distance between a picture of a current frame and a forward reference frame as shown in FIG. 1,
when a current block is in a P picture, d₀ represents a distance between a picture of a current frame and a first forward reference frame as shown in FIG. 2,
when a current block is in a B picture, d₁ represents a distance between a picture of a current frame and a backward reference frame as shown in FIG. 1, and
when a current block is in a P picture, d₁ represents a distance between a picture of a current frame and a second forward reference frame as shown in FIG. 2.

For the scenario of FIG. 1, given the pair of motion vectors MV0 and MV1 that are obtained, for the current block, its forward predictions P0(MV0) can be obtained with MV0, its backward predictions P1(MV1) can be obtained with MV1, and its bi-directional predictions can be obtained with both MV0 and MV1. The bi-directional predictions can be, for example, the average of P0(MV0) and P1(MV1), or the weighted average (P0(MV0)*d1+P1(MV1)*d0)/(d0+d1). An alternative function may be used to obtain a bi-directional prediction. In an embodiment, the encoder and decoder may use the same prediction method. In an embodiment, the chosen prediction method may be identified in a standards specification or signaled in the encoded bitstream.

For the scenario of FIG. 2, the predictions for the current block may be obtained in different ways. The predictions can be P0(MV0)), P1(MV1), (P0(MV0)+P1(MV1))/2, or (P0(MV0)*d1+P1(MV1)*d0)/(d0+d1), for example. In other embodiments, other functions may be used. The predictions may be obtained in the same way at both the encoder and decoder. In an embodiment, the prediction method may be identified in a standards specification or signaled in the encoded bitstream.

In various embodiments, J₀ can be determined using the following equation.

$${J}_{0} = {\sum }_{j = 0}^{N - 1} {\sum }_{i = 0}^{M - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert$$

where,
N and M are respective y and x dimensions of the current block,
R₀ is the first FW reference frame and R₀(x+mv₀_{_{—}}x+i, y+mv₀_{_{—}}y+j) is a pixel value in R₀ at location (x+mv₀_{_{—}}x+i, y+mv₀_{_{—}}y+j),
R₁ is the first BW reference frame for mirror ME or the second FW reference frame for projective ME and R₁(x+mv₁_{_{—}}x+i, y+mv₁_{_{—}}y+j) is a pixel value in R₁ at location (x+mv₁_{_{—}}x+i, y+mv₁_{_{—}}y+j),
mv₀_{_{—}}x is a motion vector for current block in the x direction in reference frame R₀,
mv₀_{_{—}}y is a motion vector for current block in the y direction in reference frame R₀,
mv₁_{_{—}}x is a motion vector for current block in the x direction in reference frame R₁, and
mv₁_{_{—}}y is a motion vector for current block in the y direction in reference frame R₁.

When the motion vectors point to fractional pixel positions, the pixel values can be obtained through interpolation, e.g., bi-linear interpolation or the 6-tap interpolation defined in H 0.264/AVC standard specification.

Description of variable J₁ is made with reference to FIG. 3. FIG. 3 shows an extended reference block. M×N reference block 302 is extended on its four borders with the extended border sizes being W₀, W₁, H₀, and H₁, respectively. Accordingly, each of reference blocks in reference frames, R₀ and R₁, used to determine motion vectors in the scenarios of FIGS. 1 and 2 are extended according to the example of FIG. 3. In some embodiments, the metric J₁ can be calculated using the following equation.

$${J}_{1} = {\sum }_{j = - {H}_{0}}^{N + {H}_{1} - 1} {\sum }_{i = - {W}_{0}}^{M + {W}_{1} - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert - {J}_{0}$$

where,
M and N are dimensions of the original reference block. Note that dimensions of the extended reference block are (M+W₀+W₁)×(N+H₀+H₁).

Description of variable J₂ is made with reference to FIG. 4. FIG. 4 shows the spatial neighbors of the current block 402. Note that variable J₂ is made with reference to a current block as opposed to a reference block. The current block can be located in a new picture. Block 402 is the M×N pixel current block. Because the block decoding is in raster scan order, there are possibly four available spatial neighbor areas which have been decoded, i.e., left neighbor area A₀, top neighbor area A₁, top-left neighbor area A₂, and top-right neighbor area A₃. When the current block is on frame borders or not on the top or left border of its parent macroblock (MB), some of the spatial neighbor areas may not be available for the current block. Availability flags can be defined for the four areas as γ₀, γ₁, γ₂, and γ₃. An area is available if its flag equals 1 and is not available if its flag equals to 0. Then, the available spatial area is defined as Aₐᵥₐᵢₗ for the current block as follows:

Aₐᵥₐᵢₗ=γ₀A₀+γ₁A₁+γ₂A₂+γ₃A₃

Accordingly, the metric J₂ can be calculated as follows

$${J}_{2} = {\sum }_{( x , y ) ∈ {A}_{avail}} \vert C ( x , y ) - ( \begin{matrix}{ω}_{0} {R}_{0} ( x + {mv}_{0 \_} x , y + {mv}_{0 \_} y ) + \\ {ω}_{1} {R}_{1} ( x + {mv}_{1 \_} x , y + {mv}_{1 \_} y )\end{matrix} ) \vert$$

where,
C(x, y) is a pixel in a current frame within areas bordering the current block and
ω₀ and ω₁ are two weighting factors which can be set according to the frame distances between the new picture and reference frames 0 and 1 or be set to 0.5.
   If Rx represents a new picture, equal weighting can occur if a distance of R0 to Rx is to equal a distance of R1 to Rx. If R0-Rx is different than R1-Rx, then weighting factors are set accordingly based on the weighted differences.

In an embodiment, the parameters in FIG. 4 can be set but not limited to the following.

$$\{ \begin{matrix}{W}_{0} = {W}_{1} = {H}_{0} = {H}_{1} = 8 \\ {W}_{L} = {W}_{R} = {H}_{T} = 8 \\ {α}_{0} = {α}_{1} = 1.0\end{matrix}$$

FIG. 5 depicts a process in accordance with an embodiment. Block 502 includes specifying a search window in the forward reference frame when the current block is in a B picture or a first forward reference frame when the current block is in a P picture. This search window may be the same at both the encoder and decoder.

Block 504 includes specifying a search path in the forward search window. Full search or any fast search schemes can be used here, so long as the encoder and decoder follow the same search path.

Block 506 includes for each MV0 in the search path, determining (1) motion vector MV1 in search window for second reference frame and (2) a metric based on a reference block in the first reference frame and a reference block in a second reference frame pointed to by MV1. When the current block is in a B picture, for an MV0 in the search path, its mirror motion vector MV1 may be obtained in the backward search window. When the current block is in a P picture, for an MV0 in the search path, its projective motion vector MV1 may be obtained in a search window for a second forward reference frame. Here it may be assumed that the motion trajectory is a straight line during the associated time period, which may be relatively short. MV1 can be obtained as the following function of MV0, where d0 and d1 may be the distances between the current frame and each of the respective reference frames.

$$MV 1 = \frac{{d}_{1}}{{d}_{0}} MV 0$$

Block 508 includes selecting a motion vector MV0 that has the most desired metric. For example, the metric J described above can be determined and the MV0 associated with the lowest value of metric J can be selected. This MV0 may then be used to predict motion for the current block.

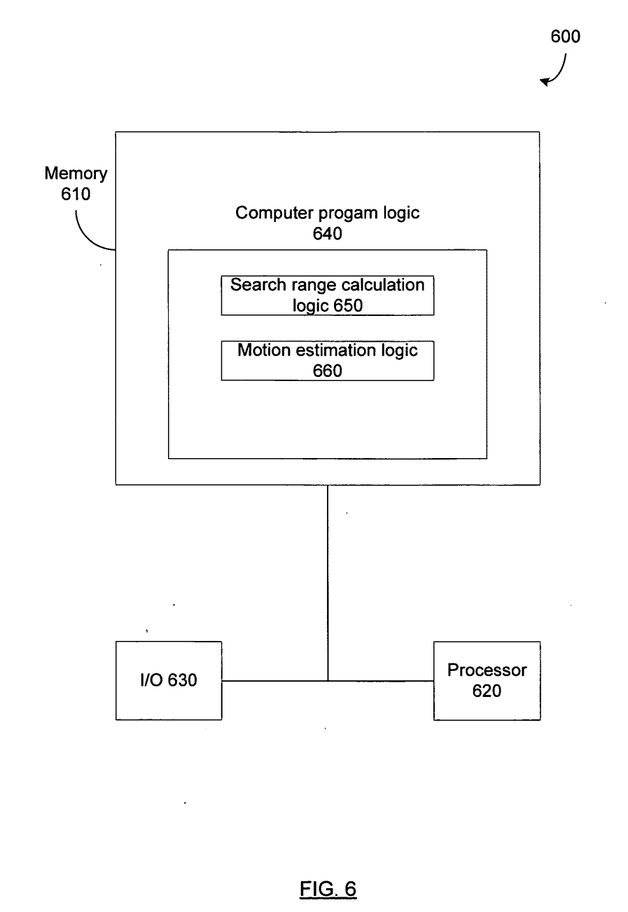

FIG. 6 illustrates an embodiment that can be used to determine motion vectors. System 600 may include a processor 620 and a body of memory 610 that may include one or more computer readable media that may store computer program logic 640. Memory 610 may be implemented as a hard disk and drive, a removable media such as a compact disk and drive, or a read-only memory (ROM) device, for example. Memory may be remotely accessed through a network by processor 620. Processor 620 and memory 610 may be in communication using any of several technologies known to one of ordinary skill in the art, such as a bus. Logic contained in memory 610 may be read and executed by processor 620. One or more I/O ports and/or I/O devices, shown collectively as I/O 630, may also be connected to processor 620 and memory 610. I/O ports can include one or more antennae for a wireless communications interface or can include a wired communications interface.

Computer program logic 640 may include motion estimation logic 660. When executed, motion estimation logic 660 may perform the motion estimation processing described above. Motion estimation logic 660 may include, for example, projective motion estimation logic that, when executed, may perform operations described above. Logic 660 may also or alternatively include, for example, mirror motion estimation logic, logic for performing ME based on temporal or spatial neighbors of a current block, or logic for performing ME based on a lower layer block that corresponds to the current block.

Prior to motion estimation logic 660 performing its processing, a search range vector may be generated. This may be performed as described above by search range calculation logic 650. Techniques performed for search calculation are described for example in U.S. patent application Ser. No. 12/582,061, filed on Oct. 20, 2009 (attorney docket no. P32772). Once the search range vector is generated, this vector may be used to bound the search that is performed by motion estimation logic 660.

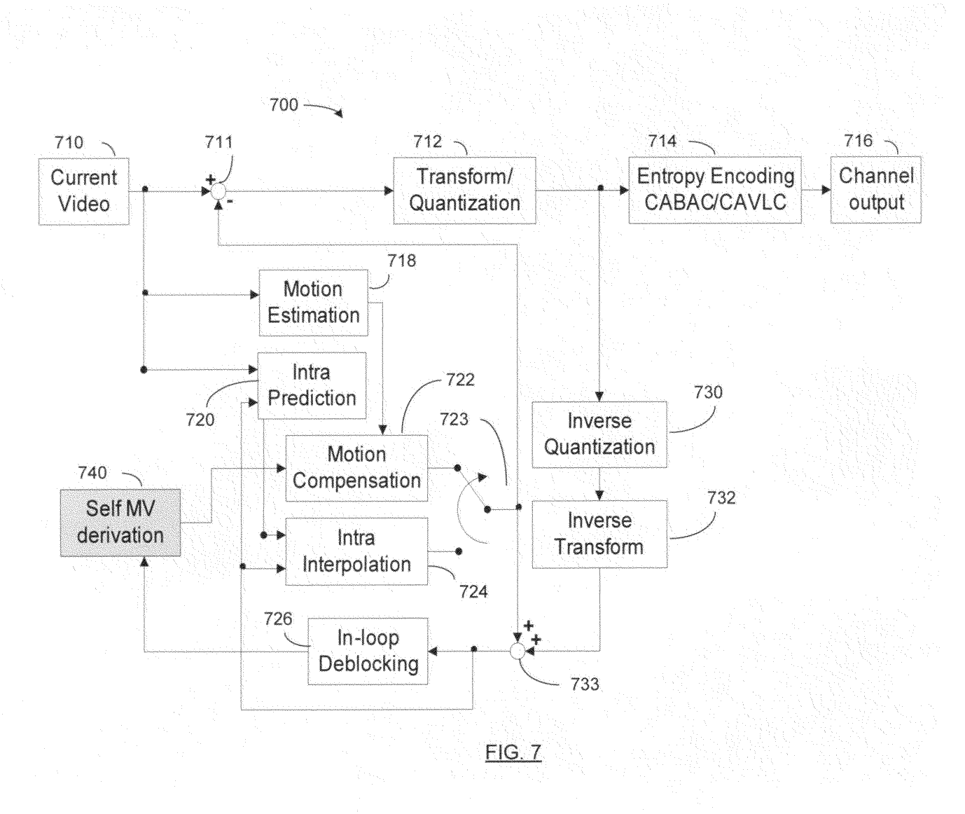

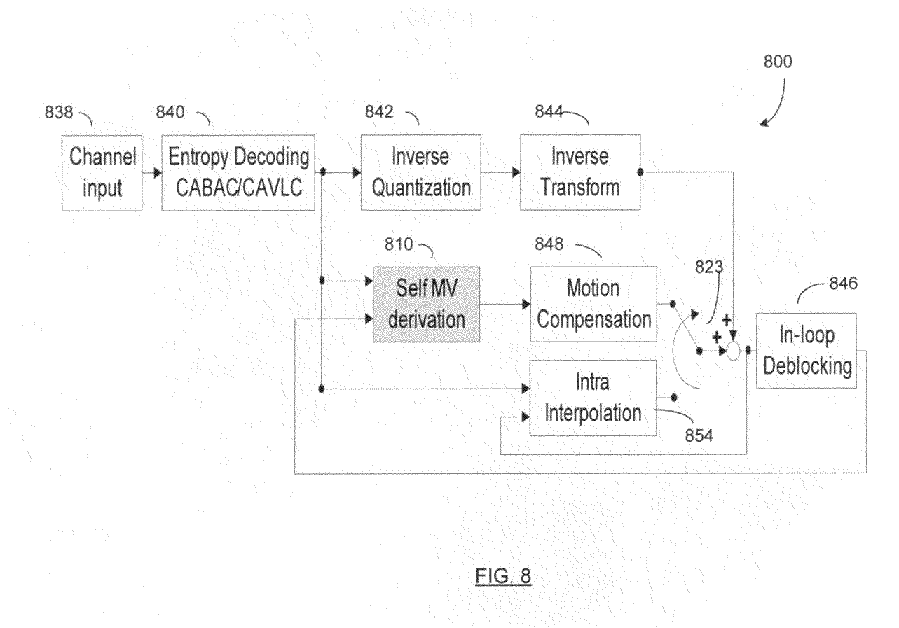

Logic to perform search range vector determination may be incorporated in a self MV derivation module that is used in a larger codec architecture. FIG. 7 illustrates an exemplary H.264 video encoder architecture 700 that may include a self MV derivation module 740, where H.264 is a video codec standard. Current video information may be provided from a current video block 710 in a form of a plurality of frames. The current video may be passed to a differencing unit 711. The differencing unit 711 may be part of the Differential Pulse Code Modulation (DPCM) (also called the core video encoding) loop, which may include a motion compensation stage 722 and a motion estimation stage 718. The loop may also include an intra prediction stage 720, and intra interpolation stage 724. In some cases, an in-loop deblocking filter 726 may also be used in the loop.

The current video 710 may be provided to the differencing unit 711 and to the motion estimation stage 718. The motion compensation stage 722 or the intra interpolation stage 724 may produce an output through a switch 723 that may then be subtracted from the current video 710 to produce a residual. The residual may then be transformed and quantized at transform/quantization stage 712 and subjected to entropy encoding in block 714. A channel output results at block 716.

The output of motion compensation stage 722 or inter-interpolation stage 724 may be provided to a summer 733 that may also receive an input from inverse quantization unit 730 and inverse transform unit 732. These latter two units may undo the transformation and quantization of the transform/quantization stage 712. The inverse transform unit 732 may provide dequantized and detransformed information back to the loop.

A self MV derivation module 740 may implement the processing described herein for derivation of a motion vector. Self MV derivation module 740 may receive the output of in-loop deblocking filter 726, and may provide an output to motion compensation stage 722.

FIG. 8 illustrates an H.264 video decoder 800 with a self MV derivation module 810. Here, a decoder 800 for the encoder 700 of FIG. 7 may include a channel input 838 coupled to an entropy decoding unit 840. The output from the decoding unit 840 may be provided to an inverse quantization unit 842 and an inverse transform unit 844, and to self MV derivation module 810. The self MV derivation module 810 may be coupled to a motion compensation unit 848. The output of the entropy decoding unit 840 may also be provided to intra interpolation unit 854, which may feed a selector switch 823. The information from the inverse transform unit 844, and either the motion compensation unit 848 or the intra interpolation unit 854 as selected by the switch 823, may then be summed and provided to an in-loop de-blocking unit 846 and fed back to intra interpolation unit 854. The output of the in-loop deblocking unit 846 may then be fed to the self MV derivation module 810.

The self MV derivation module may be located at the video encoder, and synchronize with the video decoder side. The self MV derivation module could alternatively be applied on a generic video codec architecture, and is not limited to the H.264 coding architecture. Accordingly, motion vectors may not be transmitted from an encoder to decoder, which can save transmission bandwidth.

Various embodiments use spatial-temporal joint motion search metric for the decoder-side ME of the self MV derivation module to improve the coding efficiency of video codec systems.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Embodiments of the present invention may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A computer-implemented method comprising:
specifying, at a video decoder, a search window in a first reference frame;
specifying a search path in the search window of the first reference frame;
for each motion vector MV0 in the search path, where each MV0 points from a current block to a reference block in the search window, determining a corresponding second motion vector MV1 that points to a reference block in a second reference frame, where the corresponding second motion vector MV1 is a function of MV0;
determining a metric for each pair of MV0 and MV1 that is found in the search path, wherein the metric comprises a combination of a first, second, and third metrics and wherein the first metric is based on temporal frame correlation, a second metric based on spatial neighbors of the reference blocks, and a third metric based on the spatial neighbors of the current block;
selecting the MV0 whose corresponding value for the metric is a desirable value, where the selected MV0 is used as a motion vector for the current block; and
providing a picture for display, wherein the picture for display is based in part on the selected MV0.

2. The method of claim 1, wherein the determining a metric comprises:
determining a weighted average of the first, second, and third metrics.

3. The method of claim 1, wherein the determining a metric comprises:
determining a first metric based on:
$${J}_{0} = {\sum }_{j = 0}^{N - 1} {\sum }_{i = 0}^{M - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert$$
where,
N and M are respective y and x dimensions of the current block,
R₀ comprises a first forward reference frame and R₀(x+mv₀_{_{—}}x+i, y+mv₀_{_{—}}y+j) comprises a pixel value in R₀ at location (x+mv₀_{_{—}}x+i, y+mv₀_{_{—}}y+j),
R₁ comprises a first backward reference frame for mirror ME or a second forward reference frame for projective ME and R₁(x+mv₁_{_{—}}x+i, y+mv₁_{_{—}}y+j) comprises a pixel value in R₁ at location (x+mv₁_{_{—}}x+i, y+mv₁_{_{—}}y+j),
mv₀_{_{—}}x comprises a motion vector for current block in the x direction in reference frame R₀,
mv₀_{_{—}}y comprises a motion vector for current block in the y direction in reference frame R₀,
mv₁_{_{—}}x comprises a motion vector for current block in the x direction in reference frame R₁, and
mv₁_{_{—}}y comprises a motion vector for current block in the y direction in reference frame R₁.

4. The method of claim 3, wherein the determining a metric comprises:
determining a second metric based on:
$${J}_{1} = {\sum }_{j = - {H}_{0}}^{N + {H}_{1} - 1} {\sum }_{i = - {W}_{0}}^{M + {W}_{1} - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert - {J}_{0}$$

5. The method of claim 4, wherein the determining a metric comprises:
determining a third metric based on:
$${J}_{2} = {\sum }_{( x , y ) ∈ {A}_{avail}} \vert C ( x , y ) - ( \begin{matrix}{ω}_{0} {R}_{0} ( x + {mv}_{0 \_} x , y + {mv}_{0 \_} y ) + \\ {ω}_{1} {R}_{1} ( x + {mv}_{1 \_} x , y + {mv}_{1 \_} y )\end{matrix} ) \vert$$
where,
Aₐᵥₐᵢₗ comprises an area around the current block,
C(x,y) comprises a pixel in a current frame within areas bordering the current block, and
ω₀ and ω₁ are two weighting factors which can be set according to the frame distances between the new picture and reference frames 0 and 1.

6. The method of claim 1, wherein:
the current block is in a bi-predictive picture,
the first forward reference frame comprises a forward reference frame, and
the second forward reference frame comprises a backward reference frame.

7. The method of claim 1, wherein:
the current block is in a predictive picture,
the first forward reference frame comprises a first forward reference frame, and
the second forward reference frame comprises a second forward reference frame.

8. The method of claim 1, wherein the metric comprises a sum of absolute differences value and the desirable value comprises a lowest sum of absolute differences value.

9. The method of claim 1, further comprising:
at an encoder, determining a motion vector for the current block by:
specifying a second search window in a third reference frame;
specifying a second search path in the second search window of the third reference frame;
for each motion vector MV2 in the second search path, where each MV2 points from the current block to a reference block in the second search window, determining a corresponding second motion vector MV3 that points to a reference block in a fourth reference frame;
determining a metric for each pair of MV2 and MV3 that is found in the second search path, wherein the metric comprises a combination of the first, second, and third metrics; and
selecting the MV2 whose corresponding value for the metric is a desirable value, where the selected MV2 is used as a motion vector for the current block.

10. A video decoder comprising:
logic to determine each motion vector MV0 in a search path, where each MV0 points from a current block to a reference block in a search window,
logic to determine a corresponding second motion vector MV1 that points to a reference block in a second reference frame, where the corresponding second motion vector MV1 is a function of MV0;
logic to determine a metric for each pair of MV0 and MV1 that is found in the search path, wherein the metric comprises a combination of a first, second, and third metrics and wherein the first metric is based on temporal frame correlation, a second metric based on spatial neighbors of the reference blocks, and a third metric based on the spatial neighbors of the current block; and
logic to select the MV0 whose corresponding value for the metric is a desirable value, where the selected MV0 is used as a motion vector for the current block.

11. The decoder of claim 10, further comprising:
logic to specify the search window in the first reference frame;
logic to specify the search path in the search window of the first reference frame; and
logic to specify a search window in the second reference frame.

12. The decoder of claim 10, wherein to determine a metric, the logic is to:
determine a first metric based on:
$${J}_{0} = {\sum }_{j = 0}^{N - 1} {\sum }_{i = 0}^{M - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert$$
where,
N and M are respective y and x dimensions of the current block,
mv₀_{_{—}}x comprises a motion vector for current block in the x direction in reference frame R₀,
mv₀_{_{—}}y comprises a motion vector for current block in the y direction in reference frame R₀,
mv₁_{_{—}}x comprises a motion vector for current block in the x direction in reference frame R₁, and
mv₁_{_{—}}y comprises a motion vector for current block in the y direction in reference frame R₁.

13. The decoder of claim 12, wherein to determine a metric, the logic is to:
determine a second metric based on:
$${J}_{1} = {\sum }_{j = - {H}_{0}}^{N + {H}_{1} - 1} {\sum }_{i = - {W}_{0}}^{M + {W}_{1} - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert - {J}_{0}$$

14. The decoder of claim 13, wherein to determine a metric, the logic is to:
determine a third metric based on:
$${J}_{2} = {\sum }_{( x , y ) ∈ {A}_{avail}} \vert C ( x , y ) - ( \begin{matrix}{ω}_{0} {R}_{0} ( x + {mv}_{0 \_} x , y + {mv}_{0 \_} y ) + \\ {ω}_{1} {R}_{1} ( x + {mv}_{1 \_} x , y + {mv}_{1 \_} y )\end{matrix} ) \vert$$
where,
Aₐᵥₐᵢₗ comprises an area around the current block,
C(x,y) comprises a pixel in a current frame within areas bordering the current block,
ω₀ and ω₁ are two weighting factors which can be set according to the frame distances between the new picture and reference frames 0 and 1.

15. The decoder of claim 10, wherein:
the current block is in a bi-predictive picture,
the first forward reference frame comprises a forward reference frame, and
the second forward reference frame comprises a backward reference frame.

16. The decoder of claim 10, wherein:
the current block is in a predictive picture,
the first forward reference frame comprises a first forward reference frame, and
the second forward reference frame comprises a second forward reference frame.

17. A system comprising:
a display;
a memory; and
a processor communicatively coupled to the display, the processor configured to:
determine each motion vector MV0 in a search path, where each MV0 points from a current block to a reference block in a search window,
determine a corresponding second motion vector MV1 that points to a reference block in a second reference frame, where the corresponding second motion vector MV1 is a function of MV0,
determine a metric for each pair of MV0 and MV1 that is found in the search path, wherein the metric comprises a combination of a first, second, and third metrics and wherein the first metric is based on temporal frame correlation, a second metric based on spatial neighbors of the reference blocks, and a third metric based on the spatial neighbors of the current block, and
select the MV0 whose corresponding value for the metric is a desirable value, where the selected MV0 is used as a motion vector for the current block.

18. The system of claim 17, further comprising:
a wireless network interface communicatively coupled to the processor.

19. The system of claim 17, wherein to determine the metric, the processor is to:
determine a first metric based on:
$${J}_{0} = {\sum }_{j = 0}^{N - 1} {\sum }_{i = 0}^{M - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert$$
where,
N and M are respective y and x dimensions of the current block,
mv₀_{_{—}}x comprises a motion vector for current block in the x direction in reference frame R₀,
mv₀_{_{—}}y comprises a motion vector for current block in the y direction in reference frame R₀,
mv₁_{_{—}}x comprises a motion vector for current block in the x direction in reference frame R₁, and
mv₀_{_{—}}y comprises a motion vector for current block in the y direction in reference frame R₁;
determine a second metric based on:
$${J}_{1} = {\sum }_{j = - {H}_{0}}^{N + {H}_{1} - 1} {\sum }_{i = - {W}_{0}}^{M + {W}_{1} - 1} \vert \begin{matrix}{R}_{0} ( x + {mv}_{0 \_} x + i , y + {mv}_{0 \_} y + j ) - \\ {R}_{1} ( x + {mv}_{1 \_} x + i , y + {mv}_{1 \_} y + j )\end{matrix} \vert - {J}_{0}$$
$$and$$
determine a third metric based on:
$${J}_{2} = {\sum }_{( x , y ) ∈ {A}_{avail}} \vert C ( x , y ) - ( \begin{matrix}{ω}_{0} {R}_{0} ( x + {mv}_{0 \_} x , y + {mv}_{0 \_} y ) + \\ {ω}_{1} {R}_{1} ( x + {mv}_{1 \_} x , y + {mv}_{1 \_} y )\end{matrix} ) \vert$$
where,
Aₐᵥₐᵢₗ comprises an area around the current block,
C(x,y) comprises a pixel in a current frame within areas bordering the current block,
ω₀ and ω₁ are two weighting factors which can be set according to the frame distances between the new picture and reference frames 0 and 1.

20. The system of claim 17, wherein:
when the current block is in a bi-predictive picture, the first forward reference frame comprises a forward reference frame and the second forward reference frame comprises a backward reference frame and
when the current block is in a predictive picture, the first forward reference frame comprises a first forward reference frame and the second forward reference frame comprises a second forward reference frame.
